(19) United States
(12) Patent Application Publication
(10) Pub. No.: US 2026/0083175 A1
(43) Pub. Date: Mar. 26, 2026

(54) AEROSOL GENERATING DEVICE AND METHOD OF MANUFACTURING THE SAME

(71) Applicant: KT&G CORPORATION, Daejeon (KR)

(72) Inventors: Sangkyu PARK, Seoul (KR); Hwikyeong AN, Seoul (KR); Jaemin LEE, Gyeonggi-do (KR); Daenam HAN, Seoul (KR)

(73) Assignee: KT&G CORPORATION, Daejeon (KR)

(21) Appl. No.: 19/111,648

(22) PCT Filed: Sep. 18, 2023
(86) PCT No.: PCT/KR2023/014043

§ 371 Date: Mar. 13, 2025

(30) Foreign Application Priority Data
Sep. 19, 2022 (KR) 10-2022-0118186
Dec. 2, 2022 (KR) 10-2022-0166862

(51) Int. Cl. A24F 40/465; A24F 40/20; A24F 40/70

(52) U.S. Cl. CPC A24F 40/465; A24F 40/70; A24F 40/20

(57) ABSTRACT

An aerosol generating device and a method of manufacturing the aerosol generating are provided. The aerosol generating device includes: a body comprising an insertion space; a heater pin protruding upward from a lower end of the insertion space; a heater disposed in a cavity of the heater pin; a first bonding material injected into the cavity to fix the heater; and a second bonding material injected into the cavity to cover the first bonding material so as to fill an opening of the cavity.

### TECHNICAL FIELD

The present disclosure relates to an aerosol generating device and a method of manufacturing the aerosol generating device.

### BACKGROUND ART

An aerosol generating device is a device that extracts certain components from a medium or a substance by forming an aerosol. The medium may contain a multi-component substance. The substance contained in the medium may be a multi-component flavoring substance. For example, the substance contained in the medium may include a nicotine component, an herbal component, and/or a coffee component. Recently, various research on aerosol generating devices has been conducted.

### DISCLOSURE OF INVENTION

### Technical Problem

It is an objective of the present disclosure to solve the above and other problems.

It is another objective of the present disclosure to prevent water or moisture from entering the inside of a heater pin.

It is yet another objective of the present disclosure to prevent a malfunction of a heater.

It is yet another objective of the present disclosure to improve the manufacturing efficiency of a heater assembly.

It is yet another objective of the present disclosure to reduce overheating of an aerosol generating device.

It is yet another objective of the present disclosure to prevent rotation or separation of a heater in a circumferential direction.

It is yet another objective of the present disclosure to improve the durability of a heater and a replacement period of the heater.

### Solution to Problem

According to one aspect of the subject matter described in this application, an aerosol generating device includes: a body comprising an insertion space; a heater pin protruding upward from a lower end of the insertion space; a heater disposed in a cavity of the heater pin; a first bonding material injected into the cavity to fix the heater; and a second bonding material injected into the cavity to cover the first bonding material so as to fill an opening of the cavity.

### Advantageous Effects of Invention

According to at least one of the embodiments of the present disclosure, an aerosol generating device that improves the heater and power efficiency may be provided.

According to at least one of the exemplary embodiments of the present disclosure, water or moisture may be prevented from entering the inside of a heater pin.

According to at least one of the embodiments of the present disclosure, a malfunction of a heater may be prevented.

According to at least one of the embodiments of the present disclosure, the manufacturing efficiency of a heater assembly may be improved.

According to at least one of the embodiments of the present disclosure, overheating of an aerosol generating device may be reduced.

According to at least one of the embodiments of the present disclosure, the rotation or separation of a heater in a circumferential direction may be prevented.

According to at least one of the embodiments of the present disclosure, the durability of a heater and a replacement period of the heater may be improved.

Further scope of applicability of the present disclosure will become apparent from the following detailed description. However, it should be understood that the detailed description and specific embodiments such as preferred embodiments of the present disclosure are given by way of example only, since various changes and modifications within the idea and scope of the present disclosure may be clearly understood by those skilled in the art.

### BRIEF DESCRIPTION OF DRAWINGS

FIGS. 1 to 13 illustrate examples of an aerosol generating device according to embodiments of the present disclosure.

### MODE FOR THE INVENTION

Description will now be given in detail according to exemplary embodiments disclosed herein, with reference to the accompanying drawings. For the sake of brief description with reference to the drawings, the same or equivalent components are provided with the same or similar reference numerals, and description thereof will not be repeated.

In the following description, a suffix such as “module” and “unit” may be used to refer to elements or components. Use of such a suffix herein is merely intended to facilitate description of the specification, and the suffix itself is not intended to give any special meaning or function.

In the present disclosure, that which is well known to one of ordinary skill in the relevant art has generally been omitted for the sake of brevity. The accompanying drawings are used to help easily understand the technical idea of the present disclosure and it should be understood that the idea of the present disclosure is not limited by the accompanying drawings. The idea of the present disclosure should be construed to extend to any alterations, equivalents, and substitutes besides the accompanying drawings.

It will be understood that although the terms “first”, “second”, etc. may be used herein to describe various elements, these elements should not be limited by these terms. These terms are only used to distinguish one element from another.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, a singular representation is intended to include a plural representation unless the context clearly indicates otherwise.

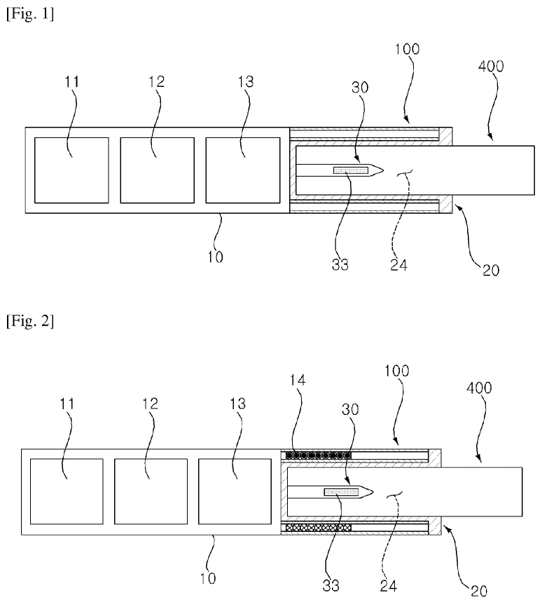

Referring to FIGS. 1 to 3, an aerosol generating device 100 may include at least one of a battery 11, a controller 12, and a sensor 13. At least one of the battery 11, the controller 12, and the sensor 13 may be disposed inside a body 10 of the aerosol generating device 100.

A pipe 20 may be coupled to an upper side of the body 10. The pipe 20 may have an insertion space 24 therein. The insertion space 24 may be open at top. The insertion space 24 may have a cylindrical shape. A stick 400 may be detachably inserted into the insertion space 24.

A heater 33 may be disposed inside a heater pin 30 protruding upward from a cover 25, which defines a bottom of the pipe 20, toward the insertion space 24. The heater 33 may be a resistive heater. The heater 33 may heat the stick 400 inserted into the insertion space 24.

When the stick 400 is inserted into the insertion space 24, one end of the stick 400 may be exposed outward of the insertion space 24 and the body 10. When the stick 400 is inserted into the insertion space 24, the heater 33 may pass through an end portion of the stick 400 to be inserted into the stick 400. The stick 400 may be heated by the heater 33. A user may inhale air while holding the one end of the stick 400 exposed to the outside in his or her mouth.

The battery 11 may supply power to operate components of the aerosol generating device 100. The battery 11 may supply power to at least one of the controller 12, the sensor 13, an induction coil 14, and the heater 33. The battery 11 may supply power required for a display, a motor, and the like installed at the aerosol generating device 100 to operate.

The controller 12 may control the overall operation of the aerosol generating device 100. The controller 12 may control the operation of at least one of the battery 11, the induction coil 14, and the sensor 13. The controller 12 may control the operation of the display, the motor, and the like installed at the aerosol generating device 100. The controller 12 may check the state of each of the components of the aerosol generating device 100 to determine whether the aerosol generating device 100 is in an operable state.

The sensor 13 may sense a temperature of the heater 33. The controller 12 may control the temperature of the heater 33 based on the temperature of the heater 33 sensed by the sensor 13. The controller 12 may transmit, through a user interface, information regarding the temperature of the heater 33 sensed by the sensor 13 to a user.

Referring to FIG. 1, the heater 33 may be electrically connected to the battery 11. The heater 33 may generate heat directly by the use of a current supplied from the battery 11, without the need for the induction coil 14 (see FIG. 2).

Referring to FIG. 2, the aerosol generating device 100 may include the induction coil 14. The induction coil 14 may surround the insertion space 24 and the heater 33. The induction coil 14 may cause the heater 33 to generate heat. The heater 33 may be a susceptor, which may generate heat by a magnetic field produced by an AC current flowing through the induction coil 14. The magnetic field may pass through the heater 33 to thereby generate an eddy current in the heater 33. The current may cause the heater 33 to generate heat.

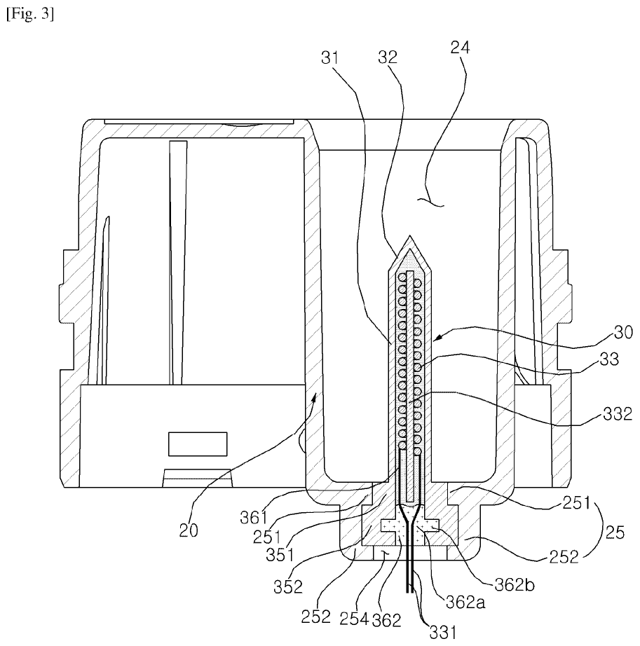

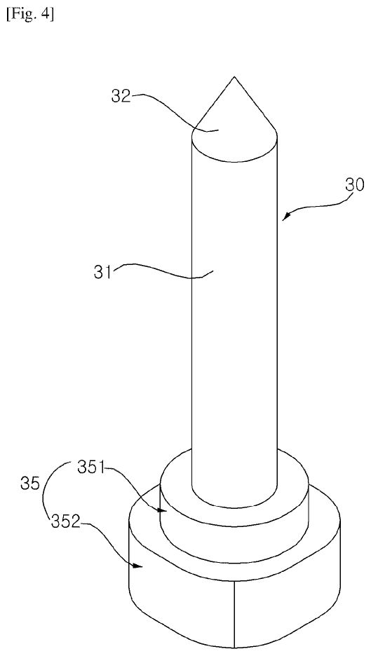

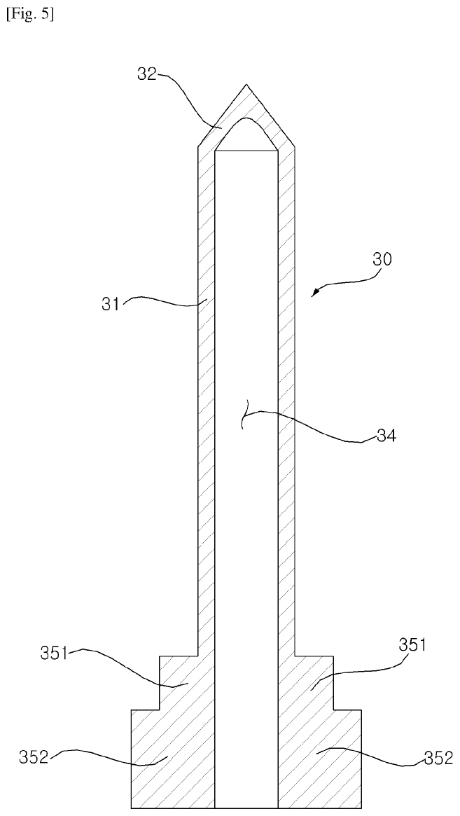

Referring to FIGS. 3 to 5, the pipe 20 may include a cover 25. The cover 25 may define a bottom of the pipe 20, and may cover a lower portion of the insertion space 24. The cover 25 may include a first cover part 251 and a second cover part 252.

The first cover part 251 may be connected to a lower end of the pipe 20. The first cover part 251 may cover a bottom of the insertion space 24. The second cover part 252 may be connected to the first cover part 251. The second cover part 252 may be formed under the first cover part 251. An inner surface of the second cover part 252 may be recessed outward relative to an inner surface of the first cover part 251. A cover hole 254 may be formed in a lower portion 2522 of the second cover part 252. The cover hole 254 may communicate with a cavity (or hollow) 34 of the heater pin 30.

The heater pin 30 may be elongated up and down or vertically. The heater pin 30 may include a cylindrical shape. The heater pin 30 may have a sharp or pointed upper end. The heater pin 30 may be provided therein with a space into which the heater 33 is inserted. The heater pin 30 may be made of a material having excellent moisture resistance, heat resistance, and thermal conductivity. For example, the heater pin 30 may be made of a ceramic material.

The heater pin 30 may include a pin body 31. The pin body 31 may be elongated vertically. The pin body 31 may have a cylindrical shape. An inside of the pin body 31 may define the cavity 34 (i.e., hollow). The heater pin 30 may be open at bottom to communicate with the cavity 34. The cavity 34 may be elongated vertically. The cavity 34 may have a cylindrical shape.

The heater pin 30 may include a pin tip 32. The pin tip 32 may define the upper end of the heater pin 30. The pin tip 32 may be integrally formed on the pin body 31. The pin tip 32 may have a shape that tapers upward. The pin tip 32 may have a sharp or pointed upper end. Accordingly, the heater pin 30 may pass through the stick S to thereby fix the stick S.

A flange 35 may protrude outward from the heater pin 30. The flange 35 may protrude from a lower end of the heater pin 30 in a lateral direction. The flange 35 may protrude from the heater pin 30 in a radially outward direction. The flange 35 may be integrally formed with the heater pin 30.

The flange 35 may be formed of a plurality of tiers. For example, the flange 35 may be formed of two tiers. For example, the flange 35 may include a first flange 351 and a second flange 352. The first flange 351 may be disposed at an upper portion (or top) of the flange 35. The second flange 352 may be disposed at a lower portion (or bottom) of the flange 35. Hereinafter, it will be described that the flange 35 includes the first flange 351 and the second flange 352. However, the present disclosure is not limited thereto, and the flange 35 may include a greater number of flanges. For example, the flange 35 may be formed of three or more tiers.

The first flange 351 may be disposed on the second flange 352. The first flange 351 may be integrally formed with the second flange 352. The first flange 351 may be disposed at a lower portion of the pin body 31. The first flange 351 may protrude from an outer circumferential surface of the pin body 31 in a laterally outward direction or the radially outward direction. The first flange 351 may extend in a circumferential direction.

The second flange 352 may be disposed underneath the first flange 351. The second flange 352 may be disposed at the lower end of the heater pin 30. The second flange 352 may protrude from the outer circumferential surface of the pin body 31 in the laterally outward direction or the radially outward direction. The second flange 352 may protrude further in the laterally outward direction or the radially outward direction than the first flange 351.

Accordingly, a step (or stepped portion) may exist between the first flange 351 and the second flange 352.

At least one of the first flange 351 and the second flange 352 may have a non-circular cross section. For example, the first flange 351 may extend in the circumferential direction to have a circular cross-sectional shape, and the second flange 352 may have a non-circular cross-sectional shape.

The first cover part 251 may surround and come into close contact with a lateral surface of the first flange 351. The first cover part 251 may cover or come into close contact with an upper surface of the second flange 352. An upper surface of the first flange 351, together with the first cover part 251, may face the bottom of the insertion space 24.

The second cover part 252 may surround and come into close contact with a lateral surface and an outer lower portion of the second flange 352. The second flange 352 may be disposed between the first cover part 251 and the second cover part 252 so as to be supported in an up-and-down direction or a vertical direction.

Accordingly, the cover 25 and the flange 35 may be coupled to each other to be engaged in the vertical direction so as to be supported in the vertical direction. Thus, separation of the heater pin 30 from the pipe 20 may be prevented, and the structural stability may be achieved.

In addition, the cover 25 and the flange 35 may be coupled to each other to be engaged in the circumferential direction. Accordingly, rotation of the heater pin 30 that is coupled to the pipe 20 may be prevented (see FIG. 3).

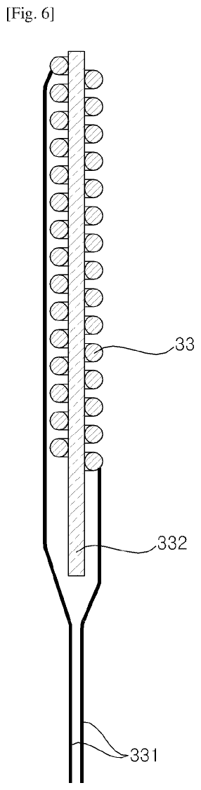

Referring to FIGS. 3 and 6, the heater 33 may have a coil shape. The heater 33 may be wound around a support bar 332 that is elongated. The support bar 332 may support the heater 33, allowing the heater 33 to be maintained in shape.

A lead wire 331 may extend long from each of both ends of the heater 33. The heater 33 may be supplied with power from a power source through the lead wire 331. The heater 33 may be a resistive heater, which may generate heat using power supplied thereto.

The heater 33 and the support bar 332 may be fixed inside the heater pin 30 by a first bonding material 361. A second bonding material 362 may cover the opening at the bottom of the heater pin 30. The lead wire 331 may pass through the second bonding material 362 and the cover hole 254 so as to be exposed downward, and may be connected to the power source.

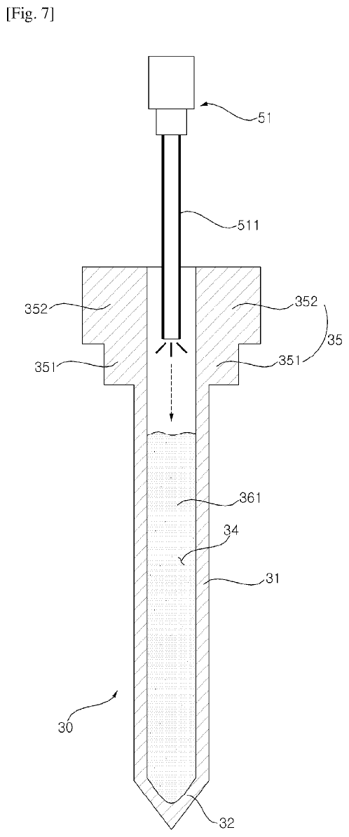

Referring to FIG. 7, a first injector 51 may store therein the first bonding material 361 in a liquid state. A first nozzle 511 of the first injector 51 may have an elongated shape. The first injector 51 may spray the liquid-state first bonding material 361 through the first nozzle 511.

The first bonding material 361 may be made of a material that is non-conductive and has excellent heat resistance and chemical resistance. For example, the first bonding material 361 may be a ceramic bonding agent (ceramic bond). The ceramic bonding agent may include raw materials such as polyurethane, amine, styrene copolymer, resin, and the like, but the present disclosure is not limited thereto. The first bonding material 361 in a liquid state may be solidified after a predetermined time at room temperature, but this may vary depending on the type of raw material constituting the first bonding material 361 or the composition ratio of the raw materials.

The heater pin 30 may be open at bottom. In a state where the heater pin 30 is turned upside down with the opening at the bottom of the heater pin 30 facing up, the first bonding material 361 in a liquid state may be injected into the cavity 34 of the heater pin 30 through the first injector 51. While being inserted into the cavity 34, the first nozzle 511 may spray the first bonding material 361 into the cavity 34. The first bonding material 361 may be injected up to a height adjacent to the opening of the heater pin 30. For example, based on the heater pin 30 being turned upside down, the first bonding material 361 may be injected up to a lower side of the flange 35.

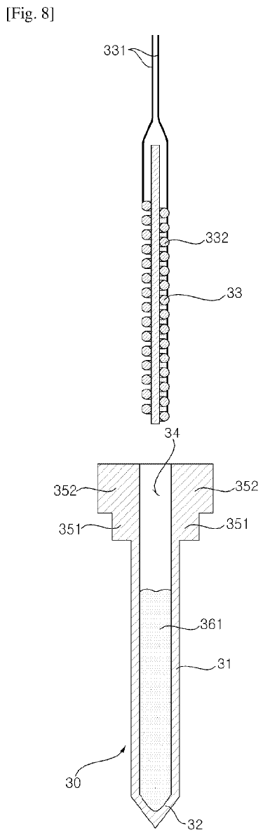

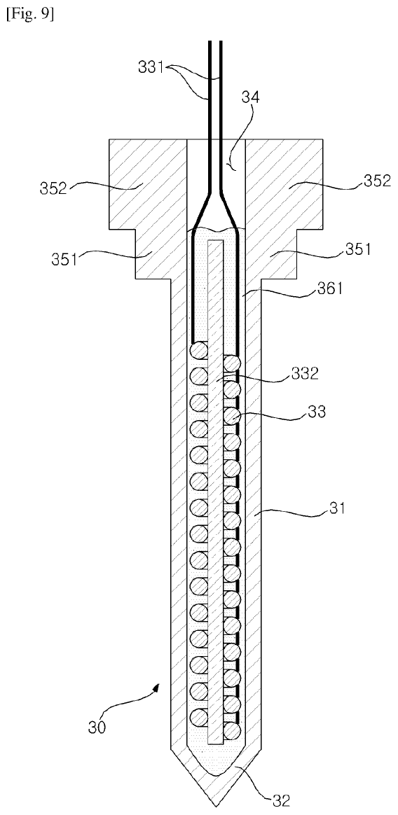

Referring to FIGS. 8 and 9, in a state where the heater pin 30 is turned upside down, the heater 33 and the support bar 332 may be inserted into the cavity 34 through the opening at the bottom of the heater pin 30. The heater 33 and the support bar 332 may be inserted into the liquid-state first bonding material 361 injected into the cavity 34. The support bar 332 and the heater 33 may be completely submerged in the first bonding material 361. As the heater 33 is wound around the support bar 332 and is supported by the support bar 332, the shape of the heater 33 may be maintained when inserted into the first bonding material 361. Here, the lead wire 331 may extend from the heater 33 to an outside of the cavity 34 through the opening of the heater pin 30, so as to be exposed below the heater pin 30.

The support bar 332 may be disposed in the cavity 34 to be parallel with the pin body 31. The heater 33 may be disposed between the pin body 31 and the support bar 332 inside the cavity 34. The first bonding material 361 may fill gaps among the pin body 31, the support bar 332, and the heater 33 in the cavity 34. After the heater 33 and the support bar 332 are inserted into the cavity 34, the first bonding material 361 may be dried for a predetermined time and solidified into a solid state. The first bonding material 361 may be bonded and fixed to an inner surface of the pin body 31. The first bonding material 361 may be bonded and fixed to the heater 33 and the support bar 332. The first bonding material 361 may fix or secure the heater 33 and the support bar 332 to the heater pin 30.

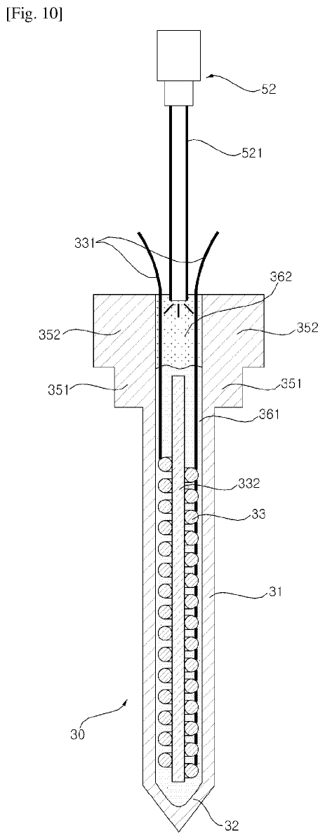

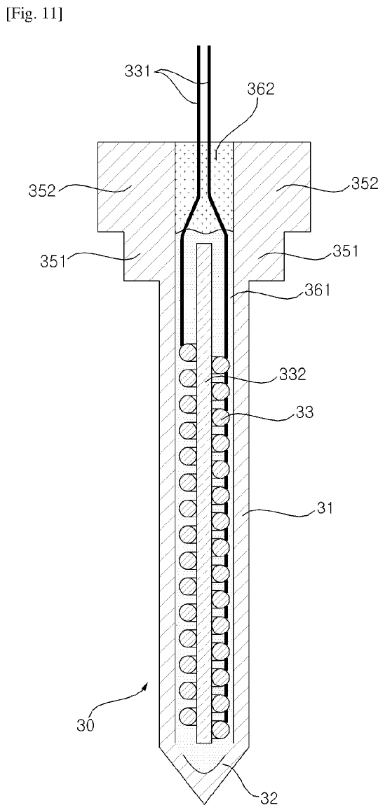

Referring to FIGS. 10 and 11, a second injector 52 may store therein the second bonding material 362 in a liquid state. A second nozzle 521 of the second injector 52 may have an elongated shape. The second injector 51 may spray the liquid-state second bonding material 361 through the second nozzle 521.

The second bonding material 362 may be made of a material that is non-conductive and has excellent heat resistance and chemical resistance. For example, the second bonding material 362 may be a ceramic bonding agent (ceramic bond). The ceramic bonding agent may include raw materials such as polyurethane, amine, styrene copolymer, resin, and the like, but the present disclosure is not limited thereto. The second bonding material 362 in a liquid state may be solidified after a predetermined time at room temperature, but this may vary depending on the type of raw material constituting the second bonding material 362 or the composition ratio of the raw materials.

In a state where the first bonding material 361 is dried and solidified into a solid state, and the heater pin 30 is turned upside down with the opening at the bottom of the heater pin 30 facing up, the second bonding material 362 in a liquid state may be injected into the cavity 34 of the heater pin 30. The second nozzle 251, while being inserted into the cavity 34 to be adjacent to the opening of the heater pin 30, may spray the second bonding material 362 into the cavity 34, namely, onto the first bonding material 361. The second bonding material 362 may be disposed under the first bonding material 361 (see FIG. 3).

The second bonding material 362 may be injected up to the lower end of the heater pin 30. The second bonding material 362 may fill the opening of the heater pin 30. A portion of the lead wire 331 may be disposed in the second bonding material 362. The lead wire 331 may pass through the second bonding material 362 so as to be exposed to an outside of the heater pin 30.

The second bonding material 362 may be dried and solidified into a solid state. The second bonding material 362 may fill the opening of the heater pin 30 and seal around the opening of the heater pin 30. The second bonding material 362 may be bonded to an inner surface of the heater pin 30 around the opening of the heater pin 30.

The material of the first bonding material 361 may be selected by considering the manufacturing efficiency, errors in manufacturing, and thermal transmittance of the heater assembly, and the like, while the material of the second bonding material 362 may be selected by considering the manufacturing efficiency and moisture resistance of the heater assembly, etc. This is merely an example, and other considerations may be taken into account. Hereinafter, the properties of the first bonding material 361 and the second bonding material 362 will be described.

The first bonding material 361 may be made of a material with a low viscosity. The first bonding material 361 may have a lower viscosity than the second bonding material 362 during its liquid state. Accordingly, the first bonding material 361 may be easily injected into the cavity 34, and the heater 33 and the support bar 332 may be easily inserted into the first bonding material 361. Also, the heater 33 and the support bar 332 may be more precisely aligned with respect to the heater pin 30.

The first bonding material 361 may have high thermal conductivity, and the second bonding material 362 may have low thermal conductivity. Accordingly, heat generated from the heater 33 may pass through the first bonding material 361 and the heater pin 30, thereby efficiently heating the stick 400 that is inserted into the insertion space 24. In addition, heat generated from the heater 33 may be insulated by the second bonding material 362, influence on other components disposed below the heater pin 30 may be reduced.

The second bonding material 362 may have a higher viscosity and a greater adhesive force (or strength) than the first bonding material 361 during its liquid state. Accordingly, the second bonding material 362 may be dried and solidified into a solid state more quickly than the first bonding material 361. In addition, a bonding force between the second bonding material 362 and the inner surface of the heater pin 30 may be greater than a bonding force between the first bonding material 361 and the inner surface of the heater pin 30. Thus, the second bonding material 362 may effectively prevent liquid or moisture in the air from entering an inside of the heater pin 30.

The second bonding material 362 may be greater in at least one of moisture resistance and waterproof rating than the first bonding material 361. Moisture resistance may be obtained by measuring a change in physical properties after a predetermined period of time under specific temperature and humidity conditions. Water resistance may be referred to as water resistance rating. Water resistance, which is defined as the depth at which a material can withstand water pressure in water, may be expressed in units of mm. Accordingly, although the aerosol generating device 100 is exposed to moisture in the air for a long time, the amount of moisture absorbed by the second bonding material 362 may be small. Thus, the penetration of moisture into the heater pin 30 may be prevented, or the amount of moisture penetration may be reduced. The second bonding material 362 may have greater water repellency than the first bonding material 361. In addition, a failure or malfunction of the heater 33 due to moisture may be prevented, and the temperature of the heater 33 may be more accurately sensed and controlled.

The first bonding material 361 and the second bonding material 362 may each have high heat resistance. The first bonding material 361 and the second bonding material 362 may each have a small coefficient of thermal expansion. The heater pin 30, the first bonding material 361, and the second bonding material 362 may each be formed of a material that does not undergo thermal deformation at the maximum temperature of the heater 33 when the heater 33 generates heat.

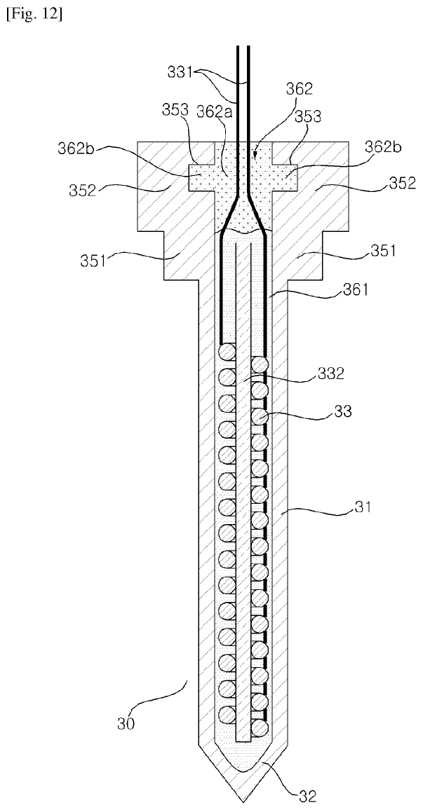

Referring to FIG. 12, the heater pin 30 may further include a depressed portion 353. The depressed portion 353 may be referred to as an outwardly recessed portion 353. With respect to a transverse or horizontal direction, an inner surface of the heater pin 30 may be recessed outward from the cavity 34, in the vicinity of the opening of the heater pin 30, to thereby define the depressed portion 253. The inner surface of the heater pin 30 may be recessed in the radially outward direction to define the depressed portion 353. The depressed portion 353 may extend in the circumferential direction. A cross-sectional shape of the depressed portion 353 may be circular, but the present disclosure is not limited thereto. Based on the cross section, a circumference of the depressed portion 353 may be greater than a circumference of the cavity 34.

The second bonding material 362 may include a central portion 362a and a protruding portion 362b. The second bonding material 362 in a liquid state may be dried into a solid state to form the central portion 362a aligned with the cavity 34. The central portion 362a may have a cylindrical shape. The second bonding material 362 in a liquid state may be injected and filled in the depressed portion 353. The liquid-state second bonding material 362 injected into the depressed portion 353 may be dried into a solid state. The solid-state second bonding material 362 filling the depressed portion 353 may be defined as the protruding portion 362b. The protruding portion 362b may protrude from the central portion 362a in the horizontal direction. The protruding portion 362b may protrude from the central portion 362a in the radially outward direction. The central portion 362a may protrude further vertically than the protruding portion 362b. The central portion 362a and the protruding portion 362b may be bonded to the inner surface of the heater pin 30.

Accordingly, due to the protruding portion 362b, a step (or stepped portion) may be formed in a gap between the central portion 362a and the inner surface of the heater pin 30, thereby preventing liquid from being introduced into a gap between the second bonding material 362 and the inner surface of the heater pin 30.

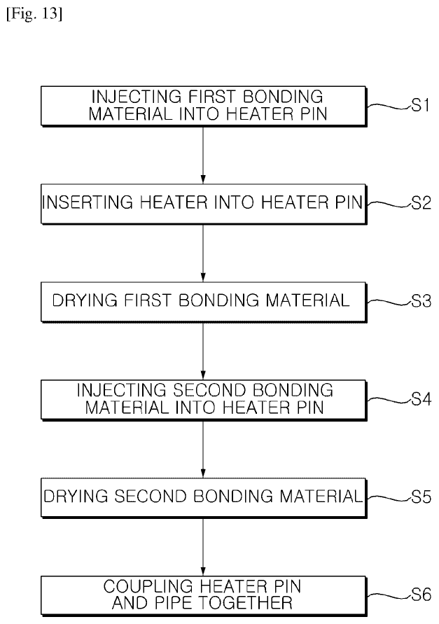

Referring to FIG. 13, a method of manufacturing the aerosol generating device 100 may include injecting the first bonding material 361 into the heater pin 30 (S1). In a state where the cavity 34 and the opening of the heater pin 30 are turned upside down to face upward, the first nozzle 511 of the first injector 51 may be inserted into the cavity 34 to inject the first bonding material 361 (see FIG. 7). Here, the first bonding material 361 may be in a liquid state.

The method of manufacturing the aerosol generating device 100 may include inserting the heater 33 into the cavity 34 of the heater pin 30 (S2). At step S2, when the first bonding material 361 is in a liquid state, the heater 33 may be inserted into the cavity 34 and the first bonding material 34 to be submerged in the first bonding material 361. Alternatively, while the heater 33 is inserted into the cavity 34, the first bonding material 361 in a liquid state may be injected into the cavity 34. Here, the heater 33 may be inserted together with the support bar 332 into the cavity 34. As the heater 33 is wound around the support bar 332, the heater 33 may be stably maintained in shape and be accurately positioned when inserted into the liquid-state first bonding material 361.

The method of manufacturing the aerosol generating device 100 may include drying the first bonding material 361 in a liquid state (S3). Here, the liquid-state first bonding material 361 may be dried into a solid state to thereby be fixed to the heater pin 30, allowing the heater 33 and the support bar 332 inside to be fixed to the heater pin 30.

The method of manufacturing the aerosol generating device 100 may include injecting the second bonding material 362 into the heater pin 30 (S4). At step S4, in a state where the cavity 34 and the opening of the heater pin 30 are turned upside down to face upward, the second nozzle 521 of the second injector 52 may be inserted into the cavity 34 to inject the second bonding material 362 from above the first bonding material 361 into the cavity 34 adjacent to the opening (see FIGS. 9 to 11). Here, the second bonding material 362 may be in a liquid state. In this case, the heater pin 30 may further include the depressed portion 353 described above, and the second bonding material 362 may be introduced into the depressed portion 353. The lead wire 331 may pass through the second bonding material 362 so as to extend outward of the heater pin 30.

The method of manufacturing the aerosol generating device 100 may include drying the second bonding material 362 in a liquid state (S5). Here, the liquid-state second bonding material 362 may be dried into a solid state to be fixed to the heater pin 30, thereby filling the opening of the heater pin 30. A portion of the lead wire 331 may be fixed by the second bonding material 362.

The method of manufacturing the aerosol generating device 100 may include coupling the heater pin 30 and the pipe 20 together (S6). Here, the pipe 20 may be formed by insert injection molding. The pipe 20 coupled with the heater pin 30 may be produced by inserting the heater pin 30, together with the heater 33, the support bar 332, the first bonding material 361, and the second bonding material 362, into a mold for injection of the pipe 20, then removing the lead wire 331 from the mold, and then injecting and solidifying an injection material into the mold.

Referring to FIGS. 1 to 13, an aerosol generating device according to an aspect of the present disclosure includes: a body comprising an insertion space; a heater pin protruding upward from a lower end of the insertion space; a heater disposed in a cavity of the heater pin; a first bonding material injected into the cavity to fix the heater; and a second bonding material injected into the cavity to cover the first bonding material so as to fill an opening of the cavity.

The second bonding material may be greater in at least water resistance or moisture resistance than the first bonding material.

The second bonding material during its liquid state may have a higher viscosity and a greater adhesive force than the first bonding material.

The second bonding material may have a lower thermal conductivity than the first bonding material.

The heater may be wound around an elongated support bar that is inserted into the cavity, and is fixed by the first bonding material.

The aerosol generating device may further include a lead wire electrically connected to the heater and extending out from the second bonding material.

The cavity of the heater pin may include an outwardly recessed portion extending radially from the cavity at a position adjacent to the opening. The second bonding material may fill the recessed portion.

Both of the first bonding material and the second bonding material may be solidified from a liquid state at room temperature to be bonded to the heater pin.

The first bonding material may be injected in a liquid state into the cavity and then be solidified with the heater inserted therein. The second bonding material may be injected into the cavity after the first bonding material is solidified.

The first bonding material and the second bonding material may be bonded to an inner surface of the cavity.

A method of manufacturing an aerosol generating device comprising a heater pin according to an aspect of the present disclosure includes: injecting a first bonding material in a liquid state into a cavity of the heater pin; inserting a heater into the cavity; solidifying the first bonding material into a solid state; injecting a second bonding material to cover the first bonding material into the cavity so as to fill an opening of the cavity; and solidifying the second bonding material into a solid state.

The heater may be inserted into the first bonding material in the liquid state injected into the cavity.

The heater may be wound around an elongated support bar that is inserted into the cavity.

The first bonding material during its liquid state may have a lower viscosity and a lower adhesive force than the second bonding material. The second bonding material may be greater in at least water resistance or moisture resistance than the first bonding material, and may be lower in thermal conductivity than the first bonding material.

The cavity of the heater pin may have an outwardly recessed portion extending radially from the cavity at a position adjacent to the opening, and wherein the second bonding material is injected to fill the recessed portion.

The second bonding material is injected such that a lead wire electrically connected to the heater extends out from the second bonding material.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings, and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings, and the appended claims. In addition to variations and modifications in the component parts and/or arrangements, alternative uses will also be apparent to those skilled in the art.

1. An aerosol generating device comprising:
a body comprising an insertion space;
a heater pin protruding upward from a lower end of the insertion space;
a heater disposed in a cavity of the heater pin;
a first bonding material injected into the cavity to fix the heater; and
a second bonding material injected into the cavity to cover the first bonding material so as to fill an opening of the cavity.

2. The aerosol generating device of claim 1, wherein the second bonding material is greater in at least water resistance or moisture resistance than the first bonding material.

3. The aerosol generating device of claim 1, wherein the second bonding material during its liquid state has a higher viscosity and a greater adhesive force than the first bonding material.

4. The aerosol generating device of claim 1, wherein the second bonding material has a lower thermal conductivity than the first bonding material.

5. The aerosol generating device of claim 1, wherein the heater is wound around an elongated support bar that is inserted into the cavity and is fixed by the first bonding material.

6. The aerosol generating device of claim 1, further comprising a lead wire electrically connected to the heater and extending out from the second bonding material.

7. The aerosol generating device of claim 1, wherein the cavity of the heater pin comprises an outwardly recessed portion extending radially from the cavity at a position adjacent to the opening, and wherein the second bonding material fills the recessed portion.

8. The aerosol generating device of claim 1, wherein both the first bonding material and the second bonding material are solidified from a liquid state at room temperature to be bonded to the heater pin.

9. The aerosol generating device of claim 8, wherein the first bonding material is injected in a liquid state into the cavity and is then solidified with the heater inserted therein, and
wherein the second bonding material is injected into the cavity after the first bonding material is solidified.

10. The aerosol generating device of claim 1, wherein the first bonding material and the second bonding material are bonded to an inner surface of the cavity.

11. A method of manufacturing an aerosol generating device comprising a heater pin, the method comprising:
injecting a first bonding material in a liquid state into a cavity of the heater pin;
inserting a heater into the cavity;
solidifying the first bonding material into a solid state;
injecting a second bonding material to cover the first bonding material into the cavity so as to fill an opening of the cavity; and
solidifying the second bonding material into a solid state.

12. The method of claim 11, wherein the heater is inserted into the first bonding material in the liquid state injected into the cavity, and wherein the heater is wound around an elongated support bar that is inserted into the cavity.

13. The method of claim 12, wherein the first bonding material during its liquid state has a lower viscosity and a lower adhesive force than the second bonding material, and
wherein the second bonding material is greater in at least water resistance or moisture resistance than the first bonding material, and is lower in thermal conductivity than the first bonding material.

14. The method of claim 11, wherein the cavity of the heater pin comprises an outwardly recessed portion extending radially from the cavity at a position adjacent to the opening, and wherein the second bonding material is injected to fill the recessed portion.

15. The method of claim 11, wherein the second bonding material is injected such that a lead wire electrically connected to the heater extends out from the second bonding material.
